(19) United States
(12) Patent Application Publication
(10) Pub. No.: US 2021/0273290 A1
(43) Pub. Date: Sep. 2, 2021

(54) METHOD FOR PRODUCING A POLYMER COMPOSITE MATERIAL FOR AN ELECTROCHEMICAL CELL BY MEANS OF A SWOLLEN POLYMER

(71) Applicant: Robert Bosch GmbH, Stuttgart (DE)

(72) Inventors: Harald Bauer, Ehningen (DE); Wolfgang Weydanz, Buckenhof (DE)

(21) Appl. No.: 17/254,369

(22) PCT Filed: Jun. 7, 2019
(86) PCT No.: PCT/EP2019/064963

§ 371 Date: Dec. 21, 2020

(30) Foreign Application Priority Data
Jun. 20, 2018 (DE) 10 2018 209 937.5

(51) Int. Cl. H01M 50/403; H01M 8/106; H01M 50/446; C25B 13/08; C25B 11/04; H01M 4/04; H01M 4/1393; H01M 4/1391; H01M 4/131; H01M 4/133; H01M 4/62; H01M 50/414

(52) U.S. Cl. CPC H01M 50/403; H01M 8/106; H01M 50/446; C25B 13/08; C25B 11/04; H01M 4/0411; H01M 50/414; H01M 4/1393; H01M 4/1391; H01M 4/131; H01M 4/133; H01M 4/625; H01M 4/623; H01M 4/0435

(57) ABSTRACT

The present invention relates to a method for producing a polymer composite material, particularly an electrode (10) and/or a separator, for an electrochemical cell, particularly for a battery cell and/or fuel cell and/or electrolysis cell. In order to improve the production of polymer composite materials, in the form of electrodes and/or separators, for example, particularly for electrochemical cells, and the properties and/or functionality thereof, such as the specific energy density and/or electrical conductivity thereof, at least one swellable polymer (1) is mixed with a solvent quantity of at least one solvent (2), which can be absorbed completely in the at least one swellable polymer (1) by swelling the at least one swellable polymer (1) and which swells the at least one swellable polymer (1), and with at least one particulate material (3, 4). A polymer composite material, particularly an electrode (10) and/or a separator, for an electrochemical cell, particularly for a battery cell and/or fuel cell and/or electrolysis cell, is then formed from the mixture (1, 2, 3, 4).

### BACKGROUND OF THE INVENTION

The present invention relates to a process for producing a polymer composite material, for example an electrode and/or a separator, for an electrochemical cell, in particular for a battery cell and/or fuel cell and/or electrolysis cell, a corresponding polymer composite material and also an electrochemical cell equipped therewith.

To produce particle-filled polymer composite materials, in particular thin particle-filled polymer composite materials, in particular for electrochemical cells such as battery cells and especially in the production of battery electrodes based on particle-filled polymer composite materials, it is possible to bond particulate materials such as active electrode materials with polymers by means of wet production processes or by means of dry production processes.

In wet production processes, a wet mixture of a liquid, for example one or more solvents, one or more particulate materials and one or more polymers is used to form a polymer composite material, for example in the form of an electrode, for an electrochemical cell. Customarily, electrodes for battery cells, e.g. lithium cells, are produced by means of a wet coating process, known as a slurry process. In wet production processes, the proportion of liquid is normally significantly greater than the proportion of voids of the materials mixed therewith (excess of liquid), so that largely insoluble particulate materials float in the liquid.

In dry production processes, a dry mixture of one or more particulate materials and one or more polymers is used and a polymer composite material, for example in the form of an electrode for an electrochemical cell, is formed therefrom without addition of liquid. Here, particles of the particulate material can be joined to the polymer or polymers by thermal adhesive bonding and/or melting and/or by mechanical polymer fibrillation.

The documents DE 10 2004 012 476 A1, DE 10 2013 221 162 A1, EP 2 357 046 A2, U.S. Pat. Nos. 4,153,661, 6,589,299 B2, 7,342,770 B2, US 2004/0037954, US 2006/0027687, US 2009/0194747 A1, WO 2005/008807 A2 and WO 2005/049700 A1 describe processes for producing electrodes.

### SUMMARY OF THE INVENTION

The present invention provides a process for producing a polymer composite material, in particular a particle-filled polymer composite material, in particular of an electrode and/or a separator, for an electrochemical cell, in particular for a battery cell and/or fuel cell and/or electrolysis cell.

In the process, at least one swellable polymer is, for example in at least one process step a), mixed with such an amount of at least one swelling solvent, in particular one which swells the at least one swellable polymer, which can be taken up completely in the at least one swellable polymer by swelling of the at least one swellable polymer and with at least one particulate material.

In other words, at least one swellable polymer is mixed with at least one swelling solvent, in particular one which swells the at least one swellable polymer, and with at least one particulate material in the process, for example in at least one process step a), with an amount of the at least one swelling solvent which can be taken up completely in the at least one swellable polymer by swelling of the at least one swellable polymer being employed or used or mixed with the at least one swellable polymer and with at least one particulate material.

A polymer composite material, for example an electrode and/or a separator, in particular for an electrochemical cell, for example for a battery cell and/or fuel cell and/or electrolysis cell, is (then) formed from the mixture, for example in a process step b).

In particular, the process can be configured for producing an electrode and/or a separator for an electrochemical cell, in particular for a battery cell and/or fuel cell and/or electrolysis cell. Here, the at least one particulate material can, in particular, comprise or be formed by at least one electrode material, for example at least one active electrode material and/or at least one particulate electrode additive, for example at least one, for example carbon-based, electrical conductor, for example (conductive) carbon black, and/or at least one particulate separator additive, for example at least one electrically insulating inorganic compound. An electrode and/or a separator for an electrochemical cell, in particular for a battery cell and/or fuel cell and/or electrolysis cell, can, in particular, be formed from the mixture, for example in process step b).

On mixing of the at least one swellable polymer with the at least one swelling solvent, the amount of the at least one swelling solvent can advantageously be taken up completely in the at least one swellable polymer by swelling of the at least one swellable polymer. As a result of the complete uptake of the at least one swelling solvent, the mixture is strictly speaking not dry but is advantageously dry at least on the surface and/or macroscopically and thus pseudo-dry and can be handled like a dry mixture. This can, for example, be advantageous for carrying out the process. For example, pseudo-dry mixtures, for example nanosize polymers, for example having an average particle size of ≤1 μm, for example HSV900, a PVDF from ARKEMA having an average particle size of about 200 nm, can, in particular in dry production processes, for example by means of dry rolling and/or dry extrusion, be picked up or taken in more readily in a calender and extruder and be, for example, more readily mechanically dispersed and/or wetted leaving behind less conglutinated material in the calender or extruder than wet mixtures which, depending on viscosity and nature of the polymer, either drip off from the surface of the processing machine or adhere in an undesirable way and can lead to irregularities in the polymer composite material to be formed, for example the electrode or separator, and/or can lead to fouling of the machine and the cleaning requirements associated therewith.

Such a mixture can be used particularly advantageously in dry production processes carried out, in particular, without (further) addition of liquid, for example for dry coating, for example by means of polymer fibrillation and/or by means of dry rolling-out and/or by means of dry extrusion and/or in dry printing, in particular by means of electrostatic charging of a powder, for example of porous or dense polymer composite materials, for example electrodes and/or separators, for electrochemical cells, for example for battery cells and/or fuel cells and/or electrolysis cells. Here, swelling solvents as additive can even have an advantageous effect on a production process, in particular an otherwise dry production process, and, for example, assist such a process. Dry production processes are carried out without addition of liquid and therefore differ from wet production processes in that neither is a liquid added in the process nor does it have to be removed again by means of, for example, complicated and in particular time-consuming, costly and energy-intensive, thermal and/or vacuum drying processes. For this reason, dry production processes such as dry coating can be simple and, in particular, time-, cost- and energy-saving. In addition, comparatively thick and, for example, also adhesively bondable layers can be formed in a simple way by dry production processes such as dry coating, which can be particularly advantageous in particular for the production of electrodes, for example of electrodes which can be adhesively bonded to a very thin, in particular, power outlet lead, for electrochemical cells.

As a result of the at least one swellable polymer being mixed with the at least one swelling solvent, the at least one swellable polymer can advantageously be swelled. A comparatively small amount of solvent can be sufficient and advantageous for this purpose.

Especially as a result of the at least one swellable polymer being firstly mixed with the at least one swelling solvent, in particular before formation of the polymer composite material, for example the electrode and/or the separator, the at least one swellable polymer can be advantageously preswollen.

Due to the (pre)swelling of the at least one swellable polymer during the course of the production of the polymer composite material, for example the electrode and/or the separator, in particular before the actual formation of the polymer composite material, for example the electrode and/or the separator, a decrease in strength and/or a dimensional change, in particular as a result of polymer swelling, can advantageously be at least significantly reduced and/or avoided on, especially subsequent, contact of the in particular (pre)swollen, swellable polymer with a liquid electrolyte, for example on introduction of liquid electrolyte into a cell provided with the polymer composite material, in particular the electrode and/or the separator.

In addition, filling of the cell with liquid electrolyte can advantageously be accelerated in this way. For example, filling of the cell can be accelerated by the (pre)swollen polymer having already attained its mechanical target state or at least being shortly before this point and the process time which would otherwise be required for complete swelling of polymers by the liquid electrolyte and can take days thus being able to be significantly shortened during filling of the cell with liquid electrolyte. In addition, voids and/or pores can be filled with the liquid electrolyte more quickly, for example within minutes to hours and, for example, not as otherwise within hours up to, in particular, even days, since the (pre)swollen polymer does not, compared to polymers which have not been (pre)swollen, draw the liquid electrolyte out again from the voids and pores by swelling, or at least does this to a significantly lesser extent. Furthermore, voids and/or pores can have been at least partly, possibly completely, filled with the at least one swelling solvent, which can, in particular, be an organic electrolyte solvent and/or itself be a liquid electrolyte and/or an ionic liquid, even before filling of the cell with liquid electrolyte. Furthermore, process steps which are otherwise customary, in particular vacuum-assisted filling of the cell with liquid electrolyte, waiting of a swelling time for the polymer, renewed, in particular vacuum-assisted, introduction of further liquid electrolyte, waiting of a further swelling time for the polymer, etc., which may even be carried out with supply of current can be at least significantly reduced and/or simplified. In addition, cells equipped with (pre)swollen polymers can advantageously be cycled immediately and, for example, form an SEI layer directly. Overall, time can thus be saved during filling of the cell with liquid electrolyte and the filling of the cell with liquid electrolyte can be accelerated in this way.

In addition, swollen polymers can advantageously be significantly softer and more elastic than unswollen polymers, which can have an advantageous effect on their bonding, for example to the at least one particulate material, for example active electrode material particles, and/or adhesive bonding positions and thus on the mechanical stability. In this way, mechanical stresses, for example due to cycling, can once again advantageously be taken up more readily.

Furthermore, the at least one swelling solvent can serve as temporary plasticizer up to filling of the cell with liquid electrolyte and, after filling of the cell with liquid electrolyte, partially diffuse into the liquid electrolyte by means of an osmotic effect and be diluted in the region of the at least one swellable polymer, with the at least one swellable polymer being fixed or solidified and as such being able to shrink, especially without a change in dimensions of the cell.

In addition, particles of the at least one particulate material, for example at least one electric conductor such as (conductive) carbon black can adhere more readily to the polymer structure of the (pre)swollen polymer partially dissolved by the at least one swelling solvent than to surfaces of untreated or unswollen polymers. Particle paths, for example conductive paths made up of at least one electric conductor, for example (conductive) carbon black, can once again be advantageously formed by the improved adhesion of the particles. Thus, the materials properties, for example the electrical conductivity, can be significantly improved, especially compared to unswollen polymers having significantly lower adhesion, in the case of which a significant proportion of the particles can be present separately from one another, for example in interstices. In addition, the proportion of particles, for example (conductive) carbon black, may also be able to be reduced by such a more efficient particle utilization, which can likewise have an advantageous effect on the materials properties, for example in the case of an electrode for an electrochemical cell advantageously on the specific energy.

In addition, the at least one swelling solvent and/or the at least one polymer swollen thereby can have an advantageous effect on the handling and the properties of the pseudo-dry mixture. For example, the at least one swelling solvent and/or the at least one polymer swollen thereby can serve as lubricant, for example be even softer than the at least one particulate material, in particular even softer than carbon-based particulate materials such as graphite, and, for example, reduce mechanical stresses, for example frictional forces and/or shear forces, and/or fluidize particles and in this way significantly reduce and possibly largely prevent particle wear, for example comminution and/or grinding and/or breaking-up, for example comminution of graphite by parting along sliding planes, and/or particle surface wear, for example of functionalized and/or coated particles, for example of active electrode material particles. In this way, the production and for example the function and/or life of a cell equipped therewith can be advantageously improved.

Furthermore, the at least one swelling solvent and/or the at least one polymer swollen thereby can bring about deagglomeration of particles, for example of the at least one particulate material and/or in particular also of the at least one swellable polymer itself, especially in the case of simultaneous use of at least one electrolyte salt and/or at least one electric conductor, such as (conductive) carbon black, for example by conducting away electric surface charges. This can, in particular, have an effect on the processability of polymers in the form of fine, for example nanosize, polymer powders such as HSV900, a PVDF from ARKEM having an average particle size of about 200 nm, and the binder distribution and homogeneity. Thus, the at least one swellable polymer and/or the at least one particulate material, for example the at least one active electrode material and/or the at least one electric conductor, can advantageously once again be utilized more effectively and materials properties such as the conductivity of the polymer composite material, for example the electrode or the separator, can be improved. In particular, it is advantageously also possible to use reduced amounts of the at least one electric conductor and/or a reduced amount of polymer and/or, for example, an increased amount of active electrode material, as a result of which, for example, the specific energy of a cell made therefrom can be increased. Thus, the production and, for example, the function of a cell provided therewith can likewise advantageously be improved, in particular by an increased specific energy and/or electrical conductivity.

Furthermore, the at least one swelling solvent and/or the at least one polymer swollen thereby can bind fine abraded material and/or fine dust, for example for fixing in the polymer composite material formed, for example the electrode or the separator, which can have an advantageous effect on the handling, process procedure and occupational safety and thus on the production process.

The at least one swelling solvent can also reduce the melting point and/or glass transition temperature of the at least one swellable polymer and, for example, the polymer can become more malleable and/or more readily and/or more quickly shapeable, for example rollable, which can likewise have an advantageous effect on production.

Part of the amount of the at least one swelling solvent may escape during formation of the at least one polymer composite material, for example the electrode or the separator, for example in process step b), for example in a production process, for example by rolling-out and/or extrusion, at an elevated temperature. Nevertheless, the amount of the at least one swelling solvent can at least partly remain in the polymer composite material, in particular in the electrode or the separator, during formation of the at least one polymer composite material, for example the electrode or the separator, for example in process step b). Smaller amounts of solvent generally do not interfere in the operation of electrochemical cells and may even have an advantageous effect on cell operation.

Overall, the production of polymer composite materials, for example in the form of electrodes and/or separators, in particular for electrochemical cells, and also the properties and/or function thereof, for example their specific energy density and/or electrical conductivity, can thus be improved by the process.

In one embodiment, the at least one swellable polymer, the at least one swelling solvent and the at least one particulate material are, for example in process step a), additionally mixed with at least one further polymer. The at least one further polymer can, in particular, be stable in the at least one swelling solvent and/or be, in particular significantly, less readily swellable, in particular barely swellable or essentially unswellable, by the at least one swelling solvent. For example, the at least one further polymer can comprise or be polytetrafluoroethylene (PTFE) and/or styrene-butadiene rubber (SBR) and/or a fluorinated rubber and/or polystyrene and/or a polyimide and/or polyether ether ketone (PEEK) and/or, especially on the cathode side, polyoxymethylene (POM). For example, styrene-butadiene rubber (SBR) and/or fluorinated rubbers can be stable in gamma-butyrolactone (GBL) and be used, for example, in combination with polyvinylidene fluoride (PVDF) swollen by gamma-butyrolactone (GBL). The at least one further polymer, for example polytetrafluoroethylene, can advantageously further improve the production process and further increase the mechanical stability of the polymer composite material, for example under mechanical and/or thermal activation, for example by heating in one of the processing steps to a temperature above the glass transition temperature of one of the polymers, but in particular below the critical temperature of the particulate material, in particular active electrode material.

In a further embodiment, the at least one swelling solvent is, for example in a process step a1), firstly mixed with the at least one particulate material, in particular with the at least one electrode material, for example with the at least one active electrode material and/or with the at least one particulate electrode additive, in particular with the at least one active electrode material.

Here, mixing can be carried out, in particular, by spraying the at least one swelling solvent onto the at least one particulate material, in particular onto the at least one electrode material, for example onto the at least active electrode material and/or onto the at least one electrode additive. Here, the at least one swelling solvent can functionalize the at least one particulate material, for example the at least one electrode material, for example active electrode material, and, for example, form a covering layer, for example in the form of an SEI film, on the surface of the at least one particulate material, in particular electrode material, for example active electrode material. In particular, the at least one swelling solvent can therefore be selected in such a way that it can form a functionalization and/or an SEI film on the at least one particulate material, for example electrode material, in particular active electrode material, in particular as early as during mixing. This can advantageously decrease cell aging and improve the low-term behavior and thus increase the life of an electrode or cell produced in this way.

For example, the at least one swellable polymer and optionally the at least one further polymer can, for example, (then) be mixed in in a process step a2) and/or a3) following the process step a1). Mixing can, for example, be effected by means of a fluidized bed. The at least one swellable polymer can be (pre)swelled by the at least one swelling solvent and/or the at least one swelling solvent can, in particular, be taken up completely in the at least one swellable polymer, so that the mixture is pseudo-dry, in particular at least on the surface or macroscopically.

The at least one swellable polymer, for example polyvinylidene fluoride and/or polyethylene oxide, and/or the at least one further polymer, for example polytetrafluoroethylene, can additionally be at least partially fibrillated. The at least one swelling solvent can advantageously serve as lubricant and decrease the friction between the particles of the at least one particulate material, for example electrode material, in particular active electrode material, by formation of a liquid film thereon and in this way protect these against damage to the material. The fibrillation can, in particular, be brought about by shear forces and/or frictional forces which can be kept very low so as to be gentle on the at least one particulate material, for example electrode material, in particular active electrode material. The fibrillation can optionally be made even more gentle on the material by a small increase in temperature. However, the at least one swellable polymer and/or the at least one further polymer can optionally also be at least partially fibrillated by means of a mixing process involving a high shear force and/or frictional force, for example by means of a jet mill and/or an extruder and/or by means of a cold gas spray method (CGS). The homogeneity and/or the mechanical stability of the polymer composite material can advantageously be increased by the fibrillation.

In one variant of this embodiment, the at least one further polymer is, for example in a process step a2) following the process step a1), mixed in and at least partially fibrillated by means of a mixing process. Here, the at least one swelling solvent can advantageously act as lubricant and decrease the friction between the particles of the at least one particulate material, for example electrode material, in particular active electrode material, by formation of a liquid film thereon and thereby protect these against damage to the material.

In order to fibrillate polytetrafluoroethylene (PTFE), even very small forces as occur during transport of PTFE powders as bulk material in delivery containers by relative particle-particle motion can advantageously be sufficient. The at least one particulate material, for example electrode material, in particular active electrode material, can therefore be subjected to gentle conditions during mixing and fibrillation by use of polytetrafluoroethylene as further polymer.

However, mixing can optionally also be carried out by means of a mixing process involving a high shear force and/or frictional force, for example by means of a jet mill and/or an extruder and/or by means of a cold gas spray method (CGS), for example when using other polymers as further polymer.

The at least one swellable polymer can, in particular, (then) be mixed in, for example in a process step a3) following the process step a2). Here, the at least one swelling solvent can, in particular, be taken up completely in the at least one swellable polymer.

For example, the polymer composite material, in particular the electrode and/or the separator, can, in particular, (then) be formed from the mixture, for example by rolling-out, in particular, for example directly, by means of a calender, and/or by pressing and/or by extrusion and/or by printing, in a process step b) following the process step a3) and/or a2).

In another embodiment, the at least one swellable polymer and the at least one swelling solvent are firstly mixed, for example in a process step A1), with the at least one particulate material, for example with the at least one particulate electrode additive, in particular carbon black. Here too, the at least one swellable polymer can be (pre)swelled by the at least one swelling solvent and/or the at least one swelling solvent can be, in particular, taken up completely in the at least one swellable polymer, so that the (pre)mixture is pseudo-dry, in particular at least on the surface or macroscopically.

Here, particles of the at least one particulate material, for example electrode additive, for example (conductive) carbon black, can, in particular, adhere better, in particular owing to agglomerate formation via liquid bridges, to the polymer structure of the swollen polymer which has been partially dissolved by the at least one swelling solvent than to surfaces of untreated or unswollen polymers and particle paths, for example conductive paths, for example made up of the at least one electric conductor, for example (conductive) carbon black, can be formed by adhesion of the particles. The materials properties, for example the electrical conductivity, can thus be significantly improved, in particular compared to unswollen polymers having a significantly lower adhesion in the case of which a substantial part of the particles can be present separately from one another, for example in interstices. In addition, more efficient particle utilization can be achieved in this way and the proportion of particles, for example of (conductive) carbon black, may also be reduced, which likewise can have an advantageous effect on the (materials) properties and/or function, for example in the case of an electrode for an electrochemical cell, advantageously on the specific energy. In addition, the at least one swelling solvent and/or the at least one polymer swollen thereby can bring about deagglomeration of particles, in particular of the at least one particulate electrode additive, for example (conductive) carbon black, and/or, in particular, also of the at least one swellable polymer itself, for example by conducting away electric surface charges.

Another particulate material, in particular the at least one active electrode material, and/or optionally the at least one further polymer can (then) be mixed in, for example in a process step A2).

Thus, clusters made up of the at least one active electrode material, the at least one polymer which has been (pre)swelled by the at least one swelling solvent and the at least one particulate electrode additive, in particular conductive carbon black, which clusters are, in contrast to the solvent-free clusters described by Lugwig, B. et al., in Sci. Rep. 6, 23150; doi: 10.1038/srep23150 (2016), solvent-containing and therefore have the abovementioned advantages of the at least one swelling solvent and the at least one polymer swollen thereby in addition to good processability, for example by means of a heated roller gap, can advantageously be produced under mild conditions.

In addition, it is thus advantageously possible for the particulate material, in particular active electrode material, which is mixed in only now not to be wetted over its area, in particular its full area, by the solvent and/or by, for example, polymer dissolved in the solvent, so that there can also be no polymer phase over the area of the active electrode material surface which could otherwise hinder the access of electrolyte and thus ions from the charging and discharging process in the future electrode.

The at least one further polymer can be added at the same time. Since at this point in time the at least one swelling solvent should have already been taken up in the at least one swelling polymer and/or the mixture should externally be dry or pseudo-dry, an undefined clumping together of the at least one further polymer can advantageously be avoided.

To achieve rapid homogenization, the other particulate material, in particular the at least one active electrode material, and the at least one further polymer can be mixed in in the form of a premix (with one another), for example in process step A2). This can be particularly advantageous if the at least one further polymer and/or the at least one swellable polymer are used in small amounts, for example in small set percentages by weight, based on the total weight of the finished mixture.

For example, the polymer composite material, in particular the electrode and/or separator, can (then) be formed from the mixture, in particular by rolling-out, in particular by means of a calender, and/or by pressing and/or by extrusion and/or by printing, in process step b).

In a further embodiment, the mixture is, optionally in a process step A3) following the process step A2), pressed to give a granular material, with the polymer composite material, in particular the electrode and/or the separator, being formed from the granular material, in particular by extrusion and/or by pressing and/or by rolling-out, in particular by means of a calender, and/or by printing, for example in process step b). The granular material can, for example, be produced from the mixture by press agglomeration, especially by means of tableting as known from the pharmaceutical industries. In this way, a flowable, pseudo-dry and nondusting and thus readily processable granular material can advantageously be used for producing the polymer composite material, for example the electrode and/or the separator, for example by extrusion and/or by means of a roller gap, in particular at an elevated temperature. For example, the granular material can firstly be molded by hot pressing to give a film and the film can then be rolled out.

For example, the formation of the polymer composite material, in particular the electrode and/or the separator, can be carried out at an elevated temperature. The formation of the polymer composite material, in particular the electrode and/or the separator, can, for example, be carried out by rolling out the mixture at an elevated temperature, in particular by means of a heated calender, to give a film.

In a further embodiment, the at least one swelling solvent has a boiling point of ≥100° C., for example ≥150° C., in particular ≥200° C. In this way, the amount of the at least one swelling solvent can be retained at least substantially, possibly completely, during formation of the polymer composite material, for example the electrode and/or the separator. In particular, the amount of the at least one swelling solvent can therefore at least substantially, for example completely, be retained in the polymer composite material, in particular in the electrode and/or in the separator.

In a further embodiment, the amount of the at least one solvent swelling, in particular, the at least one swellable polymer which can be taken up completely in the at least one swellable polymer by swelling of the at least one swellable polymer is, based on the total weight of the at least one swellable polymer, in a range from ≥2% by weight to ≤20% by weight. This has been found to be advantageous for complete absorption of the at least one swelling solvent in the at least one swellable polymer by swelling and for achieving the above-described advantages. Such an amount of solvent in the at least one swellable polymer advantageously enables porosities to be filled, especially in the case of a high boiling point of the at least one swelling solvent, for example also in the long term. Larger proportions of solvent can, for example, soften the at least one swellable polymer and weaken its structural strength.

In a further embodiment, the amount of the at least one solvent which swells, in particular, the at least one swellable polymer which can be taken up completely in the at least one swellable polymer by swelling of the at least one swellable polymer is, based on the total weight of the polymer composite material which is formed from the mixture, in particular, in process step b) and is, in particular, pseudo-dry and/or (still) not filled with liquid electrolyte, for example before filling of the cell with at least one liquid electrolyte, and/or is (still) liquid electrolyte-free, in particular based on the total weight of the electrode which is formed from the mixture, in particular, in process step b) and is, in particular, pseudo-dry and/or (still) not filled with liquid electrolyte, for example before filling of the cell with at least one liquid electrolyte, and/or is (still) liquid electrolyte-free, and/or of the separator which is formed from the mixture, in particular in process step b), and is, in particular, pseudo-dry and/or (still) not filled with liquid electrolyte, for example before filling of the cell with at least one liquid electrolyte, and/or is (still) liquid electrolyte-free in a range from ≥0.005% by weight (or 50 ppm (ppm=mass/weight per million)) or ≥0.01% by weight (or 100 ppm) to ≤5% by weight, in particular ≥0.01% by weight (or 100 ppm) to ≤3% by weight, for example in a range from ≥0.01% by weight (or 100 ppm) to ≤2% by weight, for example in a range from ≥0.03% by weight (or 300 ppm) to ≤1.2% by weight, for example from ≥0.05% by weight (or 500 ppm) to ≤0.6% by weight.

In a further embodiment, the polymer composite material which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, in particular the electrode which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free and/or the separator which is formed from the mixture or from the granular material, in particular in process step b) and is, in particular, pseudo-dry and/or (still) not filled with liquid electrolyte, for example before filling of the cell with at least one liquid electrolyte, and/or is (still) liquid electrolyte-free comprises, based on the total weight thereof, from ≥80% by weight to ≤99% by weight, in particular from ≥90% by weight to ≤99% by weight, for example from ≥95% by weight to ≤98% by weight, for example from ≥96% by weight to ≤97% by weight, of the at least one particulate material, in particular of the at least one active electrode material, for example of at least one nickel oxide and/or cobalt oxide and/or manganese oxide (NCM) and/or of graphite.

In a further embodiment, the polymer composite material which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, in particular the electrode which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free and/or the separator which is formed from the mixture or from the granular material, in particular in process step b) and is, in particular, pseudo-dry and/or (still) not filled with liquid electrolyte, for example before filling of the cell with at least one liquid electrolyte, and/or is (still) liquid electrolyte-free comprises, based on the total weight thereof, from ≥0.005% by weight or ≥0.01% by weight to ≤5% by weight, in particular from ≥0.01% by weight to ≤3% by weight, for example from ≥0.01% by weight to ≤2% by weight, for example about 1% by weight, optionally from ≥0.01% by weight to ≤1% by weight or even from ≥0.01% by weight to ≤0.5% by weight, of the at least one swellable polymer, for example of polyvinylidene fluoride and/or polyethylene oxide.

In a further embodiment, the polymer composite material which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, in particular the electrode which is formed from the mixture or from the granular material, in particular in process step b), and is, in particular pseudo-dry and/or (still) not filled with liquid electrolyte, for example before filling of the cell with at least one liquid electrolyte, and/or is (still) liquid electrolyte-free and/or the separator which is formed from the mixture or from the granular material, in particular in process step b) and is, in particular, pseudo-dry and/or (still) not filled with liquid electrolyte, for example before filling of the cell with at least one liquid electrolyte, and/or is (still) liquid electrolyte-free comprises, based on the total weight thereof, from ≥0.005% by weight to ≤5% by weight, in particular from ≥0.01% by weight to ≤2% by weight, for example from ≥0.03% by weight to ≤1.2% by weight, for example from ≥0.05% by weight to ≤0.6% by weight or up to ≤0.5% by weight or up to ≤0.4% by weight, for example about 0.2% by weight, of the at least one swelling solvent, in particular solvent which swells the at least one swellable polymer.

Preference is given to using a very small proportion of the at least one particulate electrode additive, for example the at least one electric conductor, for example (conductive) carbon black. For example, the polymer composite material which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, in particular the electrode which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, can comprise, based on the total weight thereof, ≤5% by weight, more preferably ≤3% by weight, even more preferably ≤2% by weight, for example about 2% by weight, and particularly preferably ≤1% by weight, of the at least one, in particular particulate, electrode additive, in particular of the at least one electric conductor, for example (conductive) carbon black. Small amounts of electric conductor can have an advantageous effect on the compression and/or target porosity of the electrode to be formed and/or a small amount of polymer.

Due to the at least one swelling solvent, for example gamma-butyrolactone (GBL), firstly being mixed with the at least one particulate electrode additive, in particular with the at least one electric conductor, for example (conductive) carbon black, for example with the at least one particulate electrode additive, in particular the at least one electric conductor, being suspended in the at least one swelling solvent, and the at least one swellable polymer, for example polyvinylidene fluoride (PVDF), and optionally the at least one further polymer then being mixed in, for example in a fluidized bed, use of particularly small amounts of particulate electrode additives, for example of electric conductors, for example (conductive) carbon black, can advantageously be achieved.

In a further embodiment, the polymer composite material which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, in particular the electrode which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, optionally comprises, based on the total weight thereof, from ≥0.01% by weight to ≤3% by weight, in particular from ≥0.01% by weight to ≤2% by weight, for example from ≥0.01% by weight to ≤1% by weight, optionally from ≥0.01% by weight to ≤0.5% by weight, of the at least one, in particular particulate, electrode additive, in particular of the at least one electric conductor, for example (conductive) carbon black.

Preference is given to using a very small proportion of the at least one further polymer. For example, the polymer composite material which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, in particular the electrode which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free and/or the separator which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free can comprise, based on the total weight thereof, ≤5% by weight, in particular ≤3% by weight, preferably ≤2% by weight, for example about 1% by weight or ≤1% by weight, of the at least one further polymer, for example polytetrafluoroethylene. In this way, a high specific energy of the cell can be achieved and undesirable reactions, for example of polytetrafluoroethylene at the negative electrode and/or by sweating-out of polytetrafluoroethylene, can be decreased or avoided.

In a further embodiment, the polymer composite material which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free, in particular the electrode which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free and/or the separator which is formed from the mixture or from the granular material, in particular in process step b), and is, in particular, pseudo-dry and/or (still) not filled with liquid electrolyte, for example before filling of the cell with at least one liquid electrolyte, and/or is (still) liquid electrolyte-free optionally comprises, based on the total weight thereof, from ≥0.01% by weight to ≤5% by weight, in particular from ≥0.01% by weight to ≤3% by weight, for example from ≥0.01% by weight to ≤2% by weight, for example ≥0.01% by weight to ≤1% by weight, of the at least one further polymer, for example polytetrafluoroethylene.

In a further embodiment, the at least one swellable polymer comprises or is at least one halogenated, in particular fluorinated, and/or unhalogenated, in particular unfluorinated, polyolefin, in particular polyvinylidene fluoride (PVDF) and/or poly(vinylidene fluoride-hexafluoropropylene) (PVDF-HFP) and/or polyethylene (PE) and/or polypropylene (PP), and/or at least one polyalkylene oxide, in particular polyethylene oxide (PEO), for example having ≥50 repeating units, and/or at least one polyacrylate and/or polymethacrylate, in particular polymethyl methacrylate (PMMA), and/or at least one polyacrylonitrile (PAN) and/or at least one styrene-butadiene rubber (SBR) and/or at least one alignate, for example a polymer or polymer mixture derived from brown algae, and/or at least one (poly)malonate (malonic ester) and/or polyvinylpyrrolidone (PVP) and/or carboxymethyl cellulose (CMC) and/or polystyrene (PS) and/or a copolymer thereof, in particular a copolymer comprising polyethylene oxide and/or a copolymer comprising (poly)malonate, in particular a polyethylene oxide-polystyrene copolymer and/or a polyethylene oxide-polyacrylate copolymer, and/or a mixture thereof. These polymers can be advantageous as swellable polymers.

The at least one swelling solvent can, in particular, be matched to the at least one swellable polymer. Thus, for example, gamma-butyrolactone (GBL) can be used as swelling solvent for polyvinylidene fluoride (PVDF). For carboxymethyl cellulose (CMC) and/or polyvinylpyrrolidone (PVP), it is possible to use, for example, ether and/or ethanol as swelling solvent. For polyethylene (PE) and/or polypropylene (PP) and/or polystyrene (PS), it is possible to use, for example, acetone and/or toluene and/or xylene and/or trichlorobenzene and/or tetralin as swelling solvent.

For example, the at least one swelling solvent can comprise or be at least one organic electrolyte solvent, in particular gamma-butyrolactone (GBL) (boiling point about 205° C.) and/or at least one, in particular unfluorinated or fluorinated, organic carbonate, in particular ethylene carbonate (EC) and/or ethyl methyl carbonate (EMC) and/or dimethyl carbonate (DMC) and/or diethyl carbonate (DEC) and/or vinylene carbonate (VC) (boiling point about 162° C.), and/or at least one monofluorinated, polyfluorinated or perfluorinated, organic lactone and/or at least one monofluorinated, polyfluorinated or perfluorinated, organic carbonate (likewise high boiling points) and/or at least one, in particular unfluorinated or fluorinated, for example monofluorinated, polyfluorinated or perfluorinated, oligoalkylene oxide and/or polyalkylene oxide, for example oligoethylene oxide and/or polyethylene oxide, optionally in the form of a mixture of a plurality of oligoalkylene and/or polyalkylene oxides having different numbers of repeating units (batch), for example having ≤50 repeating units, for example having ≤30 repeating units, for example at least one oligoethylene oxide and/or polyethylene oxide having ≤30 repeating units, for example having about 20 repeating units, for example PEO₂₀, and/or having about 10 repeating units, for example PEG400, and/or at least one other fluorinated, for example monofluorinated, polyfluorinated or perfluorinated, electrolyte solvent, and/or at least one ionic liquid, in particular comprising imide anions, for example sulfonylimide anions, for example bis(trifluoromethanesulfonyl)imide anions (TFSP) and/or bis(fluorosulfonyl)imide anions (FSP) and/or bis(perfluoroethanesulfonyl)imide anions (PFSP), and/or tosylate anions and/or triflate anions and/or pyrrolidinium cations, for example N-methyl-N-propylpyrrolidinium cations (PYR13), and/or at least one fluorinated, for example monofluorinated, polyfluorinated or perfluorinated, electrolyte additive, and/or at least one plasticizer, for example dibutyl phthalate (DBP). Further suitable electrolyte solvents are described, for example, by Masaki Yoshio, Ralph J. Brodd and Akiya Kozawa in the book Lithium-Ion Batteries from Science and Technologies publishers.

The at least one swelling solvent, in particular the at least one organic electrolyte solvent and/or the at least one ionic liquid and/or the at least one electrolyte additive and/or the at least one plasticizer, can be liquid and/or liquefying, in particular under process conditions, for example mixing conditions, for example be liquid and/or liquefying at room temperature and/or at a temperature which has been increased by the mixing operation and/or at a temperature which has been increased in another way, for example by introduction of heat.

In a further embodiment, the at least one swelling solvent comprises or is at least one electrolyte solvent, in particular at least one lactone, for example gamma-butyrolactone (GBL), and/or at least one organic carbonate, for example at least one acyclic and/or cyclic organic carbonate, for example ethylene carbonate (EC) and/or ethyl methyl carbonate (EMC) and/or dimethyl carbonate (DMC) and/or diethyl carbonate (DEC) and/or vinylene carbonate (VC), and/or at least one, in particular unfluorinated or fluorinated, oligoalkylene oxide and/or polyalkylene oxide, for example oligoethylene oxide and/or polyethylene oxide, optionally in the form of a mixture of a plurality of oligoalkylene and/or polyalkylene oxides having different numbers of repeating units (batch), for example having ≤50 repeating units, in particular having ≤30 repeating units, for example at least one oligoethylene oxide and/or polyethylene oxide having ≤30 repeating units, for example having about 20 repeating units, for example PEO₂₀, and/or having about 10 repeating units, for example PEG400. These organic electrolyte solvents can be particularly advantageous.

In a further, alternative or additional embodiment, the at least one swelling solvent comprises or is at least one ionic liquid. For example, the at least one ionic liquid can comprise or be formed by imide anions, for example sulfonylimide anions, for example bis(trifluoromethanesulfonyl)imide anions (TF SP) and/or bis(fluorosulfonyl)imide anions (FSP) and/or bis(perfluoroethanesulfonyl)imide anions (PFSP), and/or tosylate anions and/or triflate anions and/or pyrrolidinium cations, for example N-methyl-N-propylpyrrolidinium cations (PYR13). Such ionic liquids can be particularly advantageous.

In particular, the at least one ionic liquid can comprise or be formed by imide anions, for example sulfonylimide anions, for example bis(trifluoromethanesulfonyl)imide anions (TFSP) and/or bis(fluorosulfonyl)imide anions (FSP) and/or bis(perfluoroethanesulfonyl)imide anions (PFSP), and pyrrolidinium cations, for example N-methyl-N-propylpyrrolidinium cations (PYR13).

For example, the at least one ionic liquid can comprise or be formed by N-methyl-N-propylpyrrolidinium bis(trifluoromethanesulfonyl)imide (PYR13TFSI) and/or N-methyl-N-propylpyrrolidinium bis(fluorosulfonyl)imide (PYR13FSI) and/or N-methyl-N-propylpyrrolidinium bis(perfluoroethanesulfonyl)imide (PYR13PFSI), in particular N-methyl-N-propylpyrrolidinium bis(trifluoromethanesulfonyl)imide (PYR13TFSI) and/or N-methyl-N-propylpyrrolidinium bis(fluorosulfonyl)imide (PYR13FSI).

The at least one swelling solvent can, for example, be a binary or ternary or quaternary mixture or mixture having more than four components, which can comprise or be formed by at least two or three or four or more components selected from the group consisting of organic electrolyte solvents and/or the group consisting of ionic liquids and optionally from the group explained later consisting of electrolyte salts, for example lithium electrolyte salts. The group consisting of organic electrolyte solvents can, in particular, comprise the components indicated in connection with the at least one organic electrolyte solvent and the group consisting of ionic liquids can, in particular, comprise the components indicated in connection with the at least one ionic liquid and the group consisting of electrolyte salts can, in particular, comprise the components indicated below in connection with the at least one electrolyte salt.

For example, the at least one swelling solvent can comprise or be formed by at least one unfluorinated or fluorinated oligoalkylene oxide and/or polyalkylene oxide, in particular at least one unfluorinated or fluorinated oligoethylene oxide and/or polyethylene oxide, having ≤50 repeating units, for example oligoethylene oxide and/or polyethylene oxide having about 20 repeating units, for example PEO₂₀, and/or having about 10 repeating units, for example PEG400, and at least one electrolyte salt, for example lithium electrolyte salt, for example lithium bis(trifluoromethanesulfonyl)imide (LiTFSI), and at least one ionic liquid, for example N-methyl-N-propylpyrrolidinium bis(trifluoromethanesulfonyl)imide (PYR13TFSI) and/or N-methyl-N-propylpyrrolidinium bis(fluorosulfonyl)imide (PYR13FSI), in particular N-methyl-N-propylpyrrolidinium bis(trifluoromethanesulfonyl)imide (PYR13TFSI).

Such organic electrolyte solvents and ionic liquids do not interfere in the polymer composite material formed from the mixture, in particular the electrode and/or the separator, and can even advantageously participate in the function of the cell and have a positive influence on the properties of the cells.

In a further embodiment, the at least one swellable polymer, the at least one swelling solvent and the at least one particulate material are, for example in process step a), additionally mixed with at least one electrolyte salt, for example with at least one lithium electrolyte salt, for example lithium bis(trifluoromethanesulfonyl)imide (LiTFSI), and/or the at least one swelling solvent contains at least one electrolyte salt, for example, lithium electrolyte salt, for example lithium bis(trifluoromethanesulfonyl)imide (LiTFSI), in particular in dissolved form. In this way, the ionic conductivity and the ionic bonding to the surface and/or, in particular, also in pores of the at least one particulate material, for example active electrode material, in the polymer composite material can be improved and the function of the cell can in this way be improved further. In addition, the at least one electrolyte salt, for example lithium electrolyte salt, can optionally also serve as plasticizer for the at least one swellable polymer.

The at least one electrolyte salt, in particular the lithium electrolyte salt, can, for example, comprise or be lithium bis(trifluoromethanesulfonyl)imide (LiTFSI) and/or lithium bis(fluorosulfonyl)imide (LiFSI) and/or lithium bis(perfluoroethanesulfonyl)imide (LiPFSI) and/or lithium trifluoromethanesulfonate (lithium triflate) and/or lithium hexafluorophosphate (LiPF₆) and/or lithium perchlorate (LiClO₄) and/or lithium tetrafluoroborate (LiBF₄) and/or lithium bisoxalatoborate (LiBOB) and/or lithium bisfluorooxalatoborate, in particular lithium bis(trifluoromethanesulfonyl)imide (LiTFSI).

In a further embodiment, the polymer composite material, for example the electrode and/or the separator, in particular the electrode, is formed, for example in process step b), as, for example, a self-supporting film and/or a coating from the mixture or from the granular material by a dry production process, in particular without (further) addition of liquid, for example by dry coating and/or by dry printing and/or by means of a dry pressing operation, for example by dry rolling-out, in particular by means of a calender, and/or by dry extrusion, in particular without (further) addition of liquid.

In one embodiment, the at least one active electrode material comprises or is at least one active electrode material for a positive electrode, for example at least one transition metal oxide-based active electrode material for a positive electrode, for example at least one (lithium) nickel and/or cobalt and/or manganese oxide, for example at least one (lithium) nickel and/or cobalt and/or manganese layer oxide, for example of the general chemical formula LiNiₓCo_{y}Mn_{z}O₂, and/or at least one (lithium) nickel and/or cobalt and/or manganese spinel, for example lithium manganese spinel (LiMn₂O₄). The process can be particularly advantageous for transition metal oxide-based active electrode materials since these can in this way bind water molecules on their surfaces.

In another embodiment, the at least one active electrode material comprises or is at least one active electrode material for a negative electrode, for example at least one carbon-based active electrode material for a negative electrode, for example graphite, optionally in the form of prelithiated graphite, and/or amorphous carbon, for example hard carbons and/or soft carbons.

In a further alternative or additional embodiment, the at least one particulate electrode additive comprises or is at least one electric conductor, for example at least one carbon-based electric conductor, e.g. graphite and/or amorphous carbon, for example (conductive) carbon black and/or carbon nanotubes.

In a further embodiment, the process is designed for producing an electrochemical cell, for example a battery cell and/or a fuel cell and/or an electrolysis cell. Here, the polymer composite material, in particular the electrode and/or the separator, is installed in a cell.

If the at least one swellable polymer comprises at least one ion-conductive and/or ion-conducting, for example lithium ion-conductive and/or lithium ion-conducting, polymer, for example polyethylene oxide, for example having >50 repeating units, the cell can be a solid electrolyte cell, in particular a polymer electrolyte cell.

As an alternative or in addition, the cell can be filled with at least one liquid electrolyte and/or form a liquid electrolyte cell. The at least one liquid electrolyte can comprise at least one electrolyte solvent and at least one electrolyte salt, for example lithium electrolyte salt, which can be identical to or different from the at least one electrolyte solvent or the at least one electrolyte salt, for example lithium electrolyte salt, of the at least one swelling solvent. For example, the at least one liquid electrolyte of the cell can comprise or be ethylene carbonate (EC) and/or dimethyl carbonate (DMC) and/or ethyl methyl carbonate (EMC) as electrolyte solvent.

As regards further technical features and advantages of the process of the invention, reference may here be made explicitly to what has been said in connection with the polymer composite material of the invention, the cell of the invention and the use according to the invention and also to the figures and the description of the figures.

The invention further provides a polymer composite material, in particular an electrode or a separator, for an electrochemical cell, in particular for a battery cell and/or fuel cell and/or electrolysis cell, produced by a process according to the invention.

A polymer composite material produced by a process according to the invention can, despite a dry production process, comprise small amounts of at least one swelling solvent. A polymer composite material produced by a process according to the invention involving a dry production process can also comprise at least one at least partially fibrillated polymer.

A polymer composite material produced according to the invention, for example an electrode produced according to the invention and/or a separator produced according to the invention, can, for example after dismantling of a cell equipped therewith, be detected by analysis of the constituents, for example by means of gas chromatography and/or ion chromatography and subsequent photometric detection.

As regards further technical features and advantages of the polymer composite material of the invention, reference may explicitly be made to what has been said in connection with the process of the invention, the cell of the invention and the use according to the invention and also to the figures and the description of the figures.

Furthermore, the invention provides an electrochemical cell, for example a battery cell and/or fuel cell and/or electrolysis cell, which has been produced by a process according to the invention and/or comprises at least one polymer composite material, in particular in the form of an electrode and/or a separator, which has been produced by a process according to the invention and/or at least one polymer composite material according to the invention, in particular in the form of an electrode and/or a separator.

The cell can, for example, be a solid electrolyte cell, in particular a polymer electrolyte cell, or a liquid electrolyte cell. In particular, the cell can be a polymer electrolyte cell.

As regards further technical features and advantages of the cell of the invention, mention may explicitly be made to what has been said in connection with the process of the invention, the polymer composite material of the invention and the use according to the invention and also to the figures and the description of the figures.

Furthermore, the invention provides for the use of a mixture of at least one swellable polymer and at least one solvent which swells the at least one swellable polymer and at least one particulate material, in particular at least one electrode material, for example at least one active electrode material, and/or at least one particulate electrode additive, for example at least one, for example carbon-based, electric conductor, and/or at least one separator additive, where the mixture comprises the at least one swelling solvent in an amount which is taken up completely in the at least one swellable polymer by swelling of the at least one swellable polymer, for printing, in particular dry printing, of a particle-filled polymer composite material. Thus, a particle-filled, in particular highly particle-filled, polymer composite material, for example having a proportion of particles of ≥90% by weight, in particular ≥95% by weight, for example ≥96% by weight, for example ≥97% by weight, for example an electrode and/or a separator, for an electrochemical cell, in particular for a battery cell and/or fuel cell and/or electrolysis cell, can advantageously be produced by printing. After printing, the amount of the at least one swelling solvent can largely, for example at least substantially, possibly completely, remain in the polymer composite material, for example the electrode and/or the separator.

In dry printing, the mixture can, in particular, be electrostatically charged. Owing to the proportion of the at least one swelling solvent and the polymer which has been swelled thereby, layer thicknesses of more than 50 μm, possibly even more than 100 μm, can also advantageously be formed in this way. Thus, polymer composite materials for electrochemical cells, for example in the form of electrodes and/or separators, can be produced in a simple and inexpensive manner. As a result of the swellable polymer having already been swollen by the at least one swelling solvent during printing, an improved dimensional accuracy can advantageously be achieved.

As regards further technical features and advantages of the use according to the invention, reference may explicitly be made to what has been said in connection with the process of the invention, the polymer composite material of the invention and the cell of the invention and also to the figures and the description of the figures.

### BRIEF DESCRIPTION OF THE DRAWINGS

Further advantages and advantageous embodiments of the subject matter of the invention are illustrated by the drawings and explained in the following description. Here, it should be noted that the drawings have only a descriptive character and are not intended to restrict the invention in any way. The drawings show:

FIG. 1 a schematic flow diagram to illustrate a first embodiment of the process of the invention; and

FIG. 2 a schematic flow diagram to illustrate a second embodiment of the process of the invention.

### DETAILED DESCRIPTION

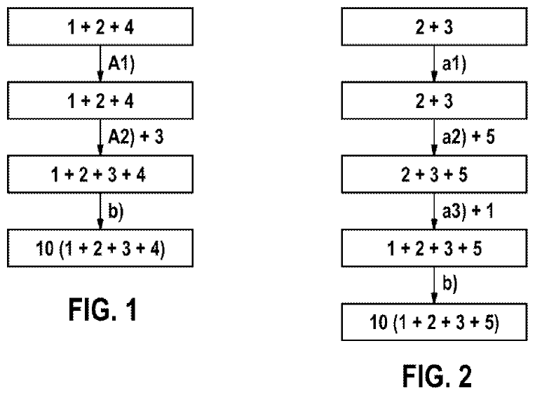

In the embodiment shown in FIG. 1, at least one swellable polymer 1, for example polyvinylidene fluoride and/or polyethylene oxide, is firstly mixed with at least one swelling solvent 2, for example gamma-butyrolactone, and with at least one particulate electrode additive 4, for example conductive carbon black, in a process step A1). Here, the at least one swelling solvent 2 is used in an amount which can be taken up completely in the at least one swellable polymer 1 by swelling of the latter.

In a process step A2), at least one active electrode material 3 and optionally at least one further polymer (not shown) is then mixed in.

In a process step b), a polymer composite material 10, in particular in the form of an electrode, for an electrochemical cell is then formed from the mixture 1, 2, 3, 4 by a dry production process, for example by dry rolling-out and/or by dry pressing and/or by dry extrusion and/or by dry printing.

The process can optionally also comprise a process step A3) (not shown), in which the mixture 1, 2, 3, 4 from process step A2) is firstly pressed to give a granular material, after process step A2) and before process step b), and the polymer composite material, in particular the electrode (10), is then formed from the granular material 1, 2, 3, 4 in process step b), in particular by extrusion and/or by pressing and/or by rolling-out, in particular by means of a calender, and/or by printing.

In the embodiment shown in FIG. 2, at least one swelling solvent 2, for example gamma-butyrolactone, is firstly mixed with at least one active electrode material 3 in a process step a1). Here, the at least one swelling solvent 2 is used in an amount which can be completely taken up in at least one swellable polymer 1 added in a later process step a3) by swelling of this polymer 1.

In a process step a2), at least one further polymer 5, for example polytetrafluoroethylene, which is, for example, stable in the at least one swelling solvent 2 and/or does not swell in 2 is then mixed in and at least partially fibrillated by the mixing process.

In a process step a3), at least one swellable polymer 1, for example polyvinylidene fluoride and/or polyethylene oxide, is then mixed in. Here, the at least one swellable polymer 1 swells with uptake of the entire amount of the at least one swelling solvent 2.

In a process step b), a polymer composite material 10, in particular in the form of an electrode 10 for an electrochemical cell, is then formed from the mixture 1, 2, 3, 5 by a dry production process, for example by dry rolling-out and/or by dry pressing and/or by dry extrusion and/or by dry printing.

### PRELIMINARY EXPERIMENTS

500 mg of nanosize polyvinylidene fluoride (PVDF) powder (HSV900 from ARKEMA having an average particle size of about 200 nm) were mixed with 100 mg of gamma-butyrolactone and the mixture was dry on the surface or macroscopically (pseudo-dry) after 30 s.

500 mg of micron-size polyvinylidene fluoride (PVDF) powder (Solev 5130 from Solvey) were mixed with 100 mg of gamma-butyrolactone and the mixture was dry on the surface or macroscopically (pseudo-dry) only after some hours.

100% strength gamma-butyrolactone does not vaporize under atmospheric pressure at room temperature and up to 60° C. because of its boiling point of about 205° C. and its vapor pressure. A sample of the liquid in a Petri dish did not lose any weight over the same period of time.

### Working Example 1

94% by weight of 111-nickel cobalt manganese oxide, 2.5% by weight of polyvinylidene fluoride, premixed or preswollen with 0.5% by weight of gamma-butyrolactone, and 3% by weight of conductive carbon black are mixed and rolled out by means of a heated calender to give a self-supporting film.

### Working Example 2

97% by weight of 111-nickel cobalt manganese oxide, 0.42% by weight of polyvinylidene fluoride, premixed or preswollen with 0.08% by weight of gamma-butyrolactone, 1% by weight of polytetrafluoroethylene and 1.5% by weight of conductive carbon black are mixed and rolled out by means of a heated calender to give a self-supporting film.

### Working Example 3

96% by weight of 111-nickel cobalt manganese oxide, 0.84% by weight of polyvinylidene fluoride premixed or preswollen with 0.16% by weight of gamma-butyrolactone, 1% by weight of polytetrafluoroethylene and 2% by weight of conductive carbon black are mixed and rolled out by means of a heated calender to give a self-supporting film.

1. A process for producing a polymer composite material, the method comprising
mixing at least one swellable polymer (1)
is mixed with such an amount of at least one swelling solvent (2) which swells the at least one swellable polymer (1) that the amount of solvent can be taken up completely in the at least one swellable polymer (1) by swelling of the at least one swellable polymer (1) and
with at least one particulate material (3, 4), and
forming a polymer composite material from the mixture (1, 2, 3, 4).

2. The process as claimed in claim 1, wherein the process is configured for producing an electrode (10) and/or a separator for an electrochemical cell and the at least one particulate material (3, 4) comprises at least one electrode material (3, 4), in particular at least one active electrode material (3), and/or at least one particulate electrode additive (4), in particular at least one electric conductor (4), or at least one particulate separator additive, in particular at least one particulate, electrically insulating inorganic compound, and
an electrode (10) and/or a separator for an electrochemical cell is formed from the mixture (1, 2).

3. The process as claimed in claim 1, wherein the at least one swellable polymer (1), the at least one swelling solvent (2) and the at least one particulate material (3, 4) are additionally mixed with at least one further polymer (5).

4. The process as claimed in claim 1, wherein
the at least one swelling solvent (2) is firstly mixed with the at least one particulate material (3, 4), in particular with the at least one electrode material (3), in particular with the at least one active electrode material (3), and
the at least one swellable polymer (1) and optionally the at least one further polymer (5) are then mixed in.

5. The process as claimed in claim 1, wherein
the at least one swelling solvent (1) is firstly mixed with the at least one particulate material, in particular with the at least one electrode material (3, 4), in particular with the at least one active electrode material (3), and
the at least one further polymer (5) is then mixed in and at least partially fibrillated by means of a mixing process, and
the at least one swellable polymer (1) is then mixed in, in particular with the at least one swelling solvent (2) being taken up completely in the at least one swellable polymer (1), and
the polymer composite material, in particular the electrode (10) and/or the separator, is formed from the mixture (1, 2, 3, 4, 5), in particular by rolling-out and/or by pressing and/or by extrusion and/or by printing.

6. The process as claimed in claim 1, wherein
the at least one swellable polymer (1) and the at least one swelling solvent (2) are firstly mixed with the at least one particulate electrode additive (4), in particular carbon black, in particular with the at least one swelling solvent (2) being taken up completely in the at least one swellable polymer (1),
the at least one active electrode material (3) and optionally the at least one further polymer (5) are then mixed in, and
the polymer composite material, in particular the electrode (10) and/or the separator, is formed from the mixture (1, 2, 3, 4, 5), in particular by rolling-out, in particular by means of a calender, and/or by pressing and/or by extrusion and/or by printing.

7. The process as claimed in claim 1, wherein the mixture (1, 2, 3, 4, 5) is firstly pressed to give a granular material, and the polymer composite material, in particular the electrode (10) and/or the separator, is formed from the granular material (1, 2, 3, 4, 5), in particular by extrusion and/or by pressing and/or by rolling-out, in particular by means of a calender, and/or by printing.

8. The process as claimed in claim 1, wherein the at least one swelling solvent has a boiling point of ≥100° C., in particular ≥150° C.

9. The process as claimed in claim 1, wherein the amount of the at least one swelling solvent (2) which can be taken up completely in the at least one swellable polymer (1) by swelling of the at least one swellable polymer (1) is, based on the total weight of the at least one swellable polymer (1), in a range from ≥2% by weight to ≤20% by weight and/or is, based on the total weight of the in particular pseudo-dry polymer composite material, in particular electrode and/or separator, formed from the mixture, in a range from ≥0.005% by weight to ≤5% by weight, in particular in a range from ≥0.01% by weight to ≤2% by weight.

10. The process as claimed in claim 1, wherein the polymer composite material, in particular electrode and/or separator, formed from the mixture or from the granular material comprises, based on the total weight thereof:
from ≥80% by weight to ≤99% by weight, in particular from ≥90% by weight to ≤99% by weight, of the at least one particulate material (3, 4), in particular active electrode material (3), in particular of at least one nickel and/or cobalt and/or manganese oxide, and/or graphite, or of the at least one separator additive, and
from ≥0.01% by weight to ≤5% by weight, in particular from ≥0.01% by weight to ≤3% by weight, of the at least one swellable polymer (1), in particular polyethylene oxide and/or polyvinylidene fluoride, and
from ≥0.005% by weight to ≤5% by weight, in particular from ≥0.01% by weight to ≤2% by weight, of the at least one swelling solvent (2), and
optionally from ≥0.01% by weight to ≤3% by weight, in particular from ≥0.01% by weight to ≤2% by weight, of the at least one particulate electrode additive (5), in particular of the at least one electric conductor, in particular carbon black, and/or
optionally from ≥0.01% by weight to ≤5% by weight, in particular from ≥0.01% by weight to ≤3% by weight, of the at least one further polymer (5), in particular polytetrafluoroethylene.

11. The process as claimed in claim 1, wherein the at least one swellable polymer (1) comprises or is at least one halogenated and/or unhalogenated polyolefin, in particular polyvinylidene fluoride and/or poly(vinylidene fluoride-hexafluoropropylene) and/or polyethylene and/or polypropylene, and/or at least one polyalkylene oxide, in particular polyethylene oxide, and/or at least one polyacrylate and/or polymethacrylate, in particular polymethyl methacrylate, and/or at least one polyacrylonitrile and/or at least one styrene-butadiene rubber and/or at least one alginate and/or at least one malonate and/or polyvinylpyrrolidone and/or carboxymethyl cellulose and/or polystyrene and/or a copolymer thereof, in particular a polyethylene oxide-polystyrene copolymer and/or a polyethylene oxide-polyacrylate copolymer, and/or a mixture thereof, and/or
wherein the at least one swelling solvent (2) comprises or is formed by at least one organic electrolyte solvent, in particular at least one lactone, in particular gamma-butyrolactone, and/or at least one organic carbonate, in particular ethylene carbonate and/or ethyl methyl carbonate and/or dimethyl carbonate and/or diethyl carbonate and/or vinylene carbonate, and/or at least one monofluorinated, polyfluorinated or perfluorinated lactone and/or at least one monofluorinated, polyfluorinated or perfluorinated organic carbonate and/or at least one unfluorinated or fluorinated oligoalkylene oxide and/or polyalkylene oxide, in particular oligoethylene oxide and/or polyethylene oxide, in particular having ≤50 repeating units, and/or at least one ionic liquid, in particular comprising imide anions, in particular bis(trifluoromethanesulfonyl)imide anions and/or bis(fluorosulfonyl)imide anions and/or bis(perfluoroethanesulfonyl)imide anions, and/or tosylate anions and/or triflate anions and/or pyrrolidinium cations, in particular N-methyl-N-propylpyrrolidinium cations.

12. The process as claimed in claim 1, wherein the at least one swellable polymer (1), the at least one swelling solvent (2) and the at least one particulate material (3, 4) are additionally mixed with at least one electrolyte salt, in particular with at least one lithium electrolyte salt, and/or wherein the at least one swelling solvent (2) contains at least one electrolyte salt, in particular lithium electrolyte salt.

13. The process as claimed in claim 1, wherein the polymer composite material, in particular the electrode (10) and/or the separator, in particular in the form of a self-supporting film and/or a coating, is formed from the mixture (1, 2, 3, 4, 5) or from the granular material by a dry production process, in particular without addition of liquid, in particular by dry coating and/or by dry printing and/or by a dry pressing operation and/or by dry rolling-out, in particular by means of a calender, and/or by dry extrusion.

14. The process as claimed in claim 1, wherein the process is configured for producing an electrochemical cell, in particular a battery cell and/or a fuel cell and/or an electrolysis cell, and the polymer composite material, in particular the electrode (10) and/or the separator, is installed in a cell, in particular with the cell being a polymer electrolyte cell or the cell being filled with at least one liquid electrolyte and being a liquid electrolyte cell.

15. A polymer composite material, in particular electrode (10) and/or separator, for an electrochemical cell, in particular for a battery cell and/or fuel cell and/or electrolysis cell, produced by a process as claimed in claim 1.

16. An electrochemical cell produced as claimed in claim 14.

17. The use of a mixture of at least one swellable polymer (1) and at least one swelling solvent (2) which swells the at least one swellable polymer (1) and at least one particulate material (3, 4), wherein the mixture comprises the at least one swelling solvent (2) in an amount which is taken up completely in the at least one swellable polymer (1) by swelling of the at least one swellable polymer (1), for, in particular dry, printing of a particle-filled polymer composite material (10).

18. A process for producing a polymer composite material, in particular an electrode (10) and/or a separator, for an electrochemical cell, in particular for a battery cell and/or fuel cell and/or electrolysis cell, the method comprising
mixing at least one swellable polymer (1)
with such an amount of at least one swelling solvent (2) which swells the at least one swellable polymer (1) that the amount of solvent can be taken up completely in the at least one swellable polymer (1) by swelling of the at least one swellable polymer (1) and
with at least one particulate material (3, 4), and
forming a polymer composite material, in particular an electrode (10) or a separator, for an electrochemical cell, from the mixture (1, 2, 3, 4).

19. An electrochemical cell comprising at least one polymer composite material as claimed in claim 15.

20. An electrochemical cell comprising at least one polymer composite material produced as claimed in claim 1.
